(19) United States
(12) Patent Application Publication
(10) Pub. No.: US 2007/0150724 A1
(43) Pub. Date: Jun. 28, 2007

(54) Data archiving and accessing methods and systems

(75) Inventor: Tzu-How Lin, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/318,651

(22) Filed: Dec. 27, 2005

(51) Int. Cl. H04L 9/00

(52) U.S. Cl. 713/155

(57) ABSTRACT

A data archiving and accessing system. The system comprises a client and a server. The client uploads transaction data and a public key. The server further comprises a database storing the transaction data and a transaction system. The transaction system implements authentication and authorization processes on the client, receives the transaction data with a public key via a transmission medium, encrypts the transaction data using the public key, associates and collocates the encrypted transaction data according to predefined tags, and stores the encrypted transaction data in the database

### BACKGROUND OF THE INVENTION

1. Field of the Invention

The invention relates to semiconductor data management methods, and more particularly, to semiconductor data archiving and accessing methods and systems.

2. Description of the Related Art

FIG. 1 is a schematic view of a conventional data archiving and accessing system. Data archiving and accessing system 1000 comprises client 1100 and server 1200. Server 1200 further comprises transaction system 1210 and archiving system 1220. A customer (client 1100) logs on to transaction system 1210 of server 1200 via the Internet utilizing secure protocols. Transaction system 1210 authenticates and authorizes the customer (client 1100) enabling subsequent upload thereby of transaction data to transaction system 1210. Transaction data, transmitted to archiving system 1220, is archived as file blocks 1231˜1235, using transaction system 1210 and sequentially stored in database 1230. Each file block may comprise different types of transaction data. File block 1231, for example, comprises Total Order Management (TOM) data, file block 1232 comprises Engineering Data Analysis (EDA) data, file block 1233 comprises mask data, file block 1234 comprises manufacturing execution system (MES) data, and file block 1235 comprises bumping (BP) data. Additionally, file blocks stored in database 1230 are indexed for query and access.

Next, the customer (client 1100) sends a query request to transaction system 1210 for access to the archived data from database 1230 or other operations. Transaction system 1210 receives the request and authenticates and authorizes the customer (client 1100). When the authentication and authorization are done, the customer (client 1100) can query transaction system 1210 to search for desired archived data (such as TOM, EDA, MASK, and others) residing in archiving system 1220 according to indexes using a system corresponding to the archived data. TOM data, for example, can only be obtained through a TOM system. When the desired archived data is located, transaction system 1210 retrieves the archived data from database 1230 and then responds to the customer (client 1100). Thus, the customer (client 1100) can obtain the archived data from server 1200.

As described, after customers are authenticated and authorized, no further security assurance checks are required, thus, data leakage may occur if administrators or hackers attempt to steal archived data without data owner authority. Additionally, as the transaction data is sequentially stored in the database, a customer must search for the entity of the historical archived data using various systems corresponding to each archived data type, which is inconvenient and inefficient.

Thus, an improved data archiving and accessing method is desirable.

### BRIEF SUMMARY OF THE INVENTION

Data archiving and accessing methods are provided. In an embodiment of such a method, tags for data archiving are defined. Authentication and authorization processes are executed. Transaction data with a public key is received via a transmission medium. The transaction data is encrypted using the public key. The encrypted transaction data is associated and collocated according to the tags. The encrypted transaction data is stored in a database.

Also disclosed are data archiving and accessing methods. In an embodiment of such a method, tags for data archiving are defined. Authentication and authorization processes are executed. Transaction data with a public key is received via a transmission medium. The transaction data is encrypted using the public key. The encrypted transaction data is associated and collocated according to the tags. The encrypted transaction data is stored in a database. A query request with a private key is received. Authentication and authorization processes are executed. Desired transaction data is located according to the tags. The desired transaction data is decrypted using the private key. A response is sent and the decrypted transaction data is transmitted.

Data archiving and accessing systems for are provided. An exemplary embodiment comprises a client, uploading transaction data and a public key, and a server, comprising a database storing the transaction data and a transaction system. The transaction system implements authentication and authorization processes on the client, receives the transaction data and public key via a transmission medium, encrypts the transaction data using the public key, associates and collocates the encrypted transaction data according to predefined tags, and stores the encrypted transaction data in the database.

Also disclosed are data archiving and accessing systems. An exemplary embodiment comprises a client, uploading transaction data and a public key, and a server, comprising a database storing the transaction data and a transaction system. The transaction system implements authentication and authorization processes on the client, receives the transaction data and public key via a transmission medium, encrypts the transaction data using the public key, associates and collocates the encrypted transaction data according to predefined tags, stores the encrypted transaction data in the database, receives a query request with a first private key from the first client, implements authentication and authorization processes on the first client, locates desired transaction data from the database according to the predefined tags, decrypts the desired transaction data using the first private key, and sends a response and transmits the decrypted transaction data to the first client.

The data archiving and accessing system further comprises a second client. The second client cannot retrieve the transaction data stored in the database using a second private key corresponding to the public key:

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional data archiving and accessing system;

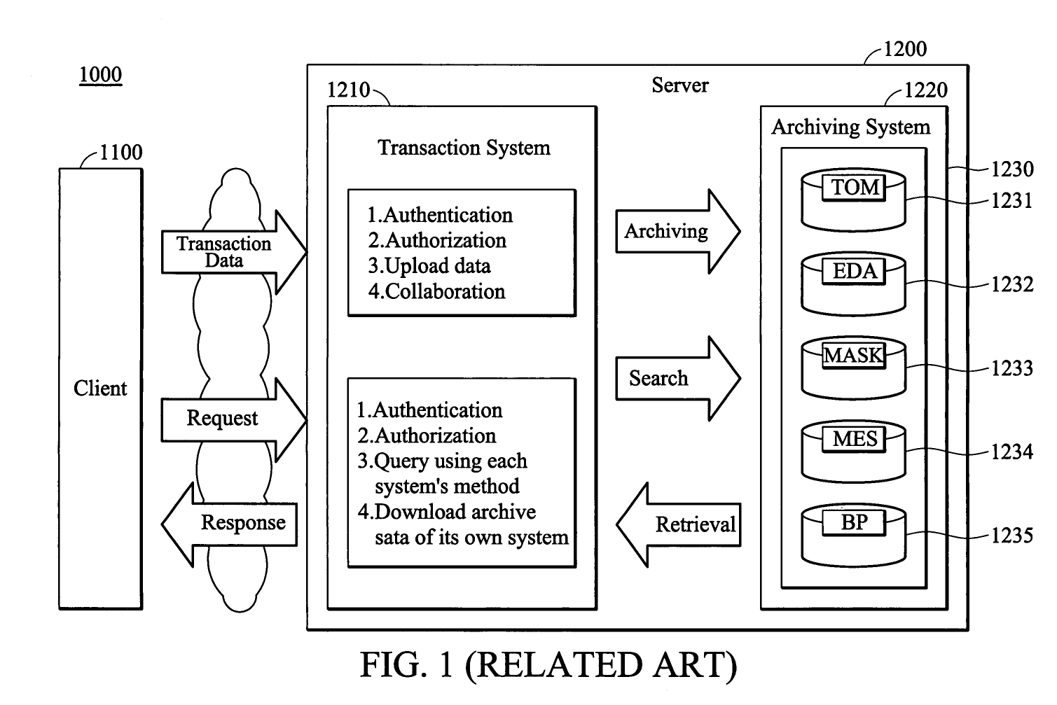

FIG. 2 is a schematic view of an embodiment of a data archiving and accessing system;

FIG. 3 is a schematic view of an example of data archiving;

FIG. 4 is a flowchart of an embodiment of a data archiving method; and

FIG. 5 is a flowchart of an embodiment of a data accessing method.

### DETAILED DESCRIPTION OF THE INVENTION

It is to be understood that the following disclosure provides many different embodiments, as examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

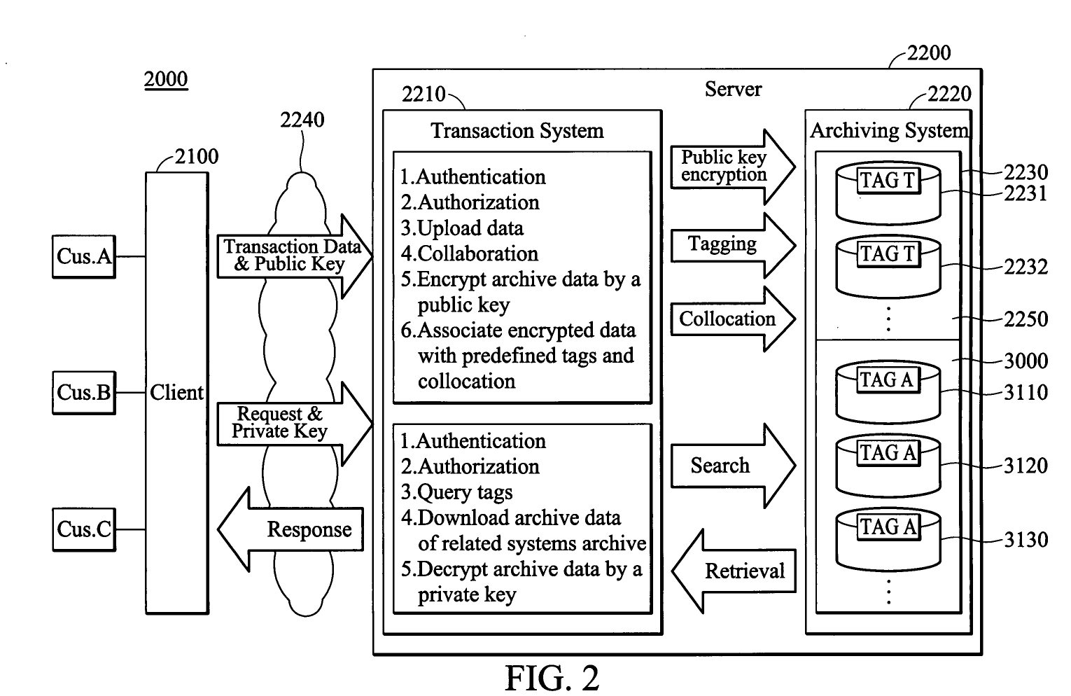

FIG. 2 is a schematic view of an embodiment of a data archiving and accessing system. Data archiving and accessing system 2000 comprises client 2100 and server 2200. Server 2200 further comprises transaction system 2210 and archiving system 2220.

A customer (client 2100) logs on to transaction system 2210 of server 2200 via a transmission medium (such as the Internet) 2240 utilizing secure protocols. Transaction system 2210 authenticates and authorizes the customer (client 2100) (customer A (Cus. A), (customer B (Cus. B), or (customer C (Cus. C) herein) enabling upload thereby of transaction data and a public key to transaction system 2210. Next, transaction system 2210 encrypts the transaction data using the public key and associates and collocates the encrypted transaction data according to predefined tags. The encrypted data for the customer, transmitted to archiving system 2220, is tagged by TAG A (indicating the data is tagged only for customer A herein), archived, as tag blocks 3110, 3120, 3130, and others (not shown), associated, collocated, and stored in customer section 3000 of database 2230. A tag block may be referred to a transaction data type (such as TOM, EDA, MASK, and others) and comprises transaction data and other corresponding attributes. Further, transaction data stored in a tag block is associated and collocated according to the predefined tags. Transaction data, for example may be associated and collocated according to manufacturers, products, processes, dates, or any other representative attributes. In other words, the manufacturers, products, processes, dates, or any other representative attributes are predefined tags.

Since transaction data is encrypted by a public key and tagged, associated, and collocated according to predefined tags, transaction data, for example, possessed by customer A (Cus. A) is associated according to TAG A and sub tags (TOM TAG, EDA TAG, and MASK TAG, for example) and collocated as at least tag blocks 3110, 3120, and 3130 according to TAG A. Transaction data possessed by customer B (Cus. B) is associated according to TAG B and at least one sub tag (MASK TAG, for example) and collocated as tag blocks (not shown) according to TAG. B. Transaction data possessed by customer C (Cus. C) is associated according to TAG C and at least one sub tag (TOM TAG, for example) and collocated as tag blocks (not shown) according to TAG C. Additionally, at least tag blocks 2231 and 2232 tagged by TAG T and stored in internal user section 2250 of database 2230 are provided by TSMC and possessed by archiving system 2220, such that customer A, B, or C cannot retrieve data relating to internal user section 2250 of database 2230 thereby.

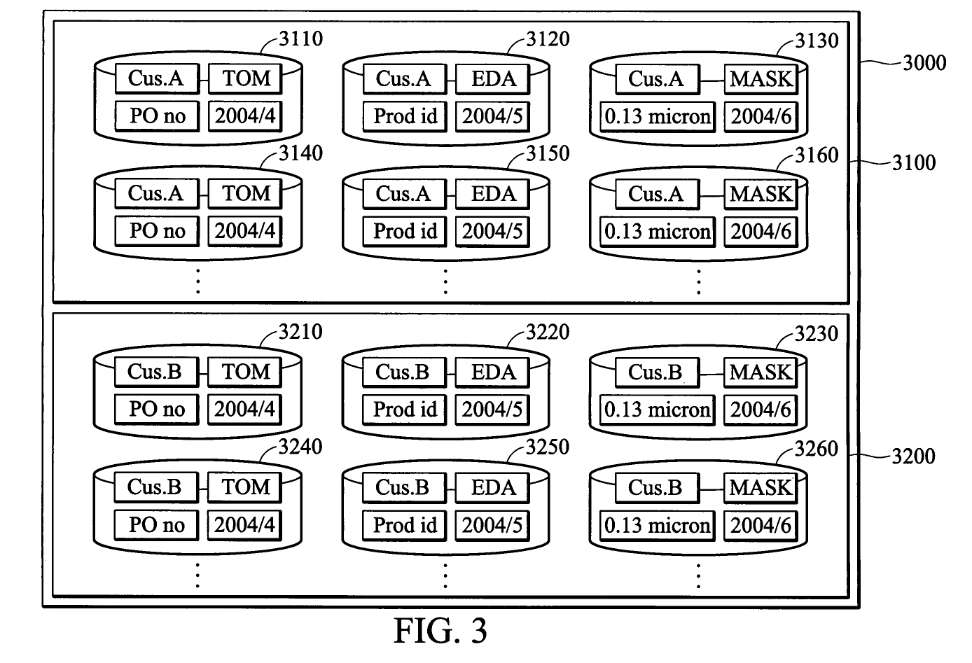

It is noted that association indicates to group different types of transaction data according to representative attributes. Referring to FIG. 3, for example, transaction data comprising a data type “TOM”, a purchase order number “PO no.”, and a date “2004/4” relating to the manufacturer “Cus. A” is associated as tagged block 3110. Collocation indicates to arrange transaction data according to a representative attribute and other sub attributes. Referring to FIG. 3, for example, tagged blocks 3210˜3260 are collocates according to the manufacturer “Cus. B” and further arranged according to data types comprising “TOM”, “EDA”, and “MASK”.

Next, when the transaction data is completely associated and collocated, the customer (client 2100) sends a query request with a private key corresponding to the public key to transaction system 2210 for access to tagged, associated, and collocated transaction data from customer section 3000 of database 2230. Transaction system 2210 authenticates and authorizes the customer (client 2100) when receiving the request. When the authentication and authorization are done, the customer (client 2100) can query transaction system 2210 to search for desired archived data. Transaction system 2210 searches for the archived data according to the predefined tags, retrieves the archived data from database 2230 of archiving system 2220, decrypts the archived data using the private key, and sends a response to the customer (client 2100). Thus, the customer (client 2100) can obtain the decrypted archived data from server 2200.

FIG. 3 is a schematic view of an example of data archiving.

Customer section 3000 of database 2230 comprises at least data collocations 3100 and 3200, possessed by different customers, customer A (Cus. A) and customer B (Cus. B), for example. Data collocation 3100 further comprises tag blocks 3110˜3160 and data collocation 3200 further comprises tag blocks 3210˜3260. As described, transaction data is associated and collocated according to predefined tags. In this embodiment, transaction data stored in each tag block comprises tags of manufacturer, data type, product parameter, and expiration date. Referring to tag block 3110 shown in FIG. 3, the manufacturer is “Cus. A”, the data type is “TOM”, the product parameter is “purchase order number” (abbreviated to PO no. in FIG. 3), and the expiration date is “2004/4”. Also, referring to tag block 3240 shown in FIG. 3, the manufacturer is “Cus. B”, the data type is “EDA”, the product parameter is “product ID” (abbreviated to Prod id. in FIG. 3), and the expiration date is “2004/5”.

Further, referring to data collocation 3100, transaction data encrypted by a public key and possessed by a customer (customer A, for example) is associated according to the tag “Cus. A” and tag blocks 3110˜3160 are collocated according to the tags “TOM”, “EDA”, and “MASK”. As a result, customer A can only access transaction data relating to tag blocks 3110˜3160 using a private key corresponding to the public key. Referring to data collocations 3200, transaction data encrypted by the public key and possessed by another customer (customer B, for example) is associated according to the, tag “Cus. B.” and tag blocks 3210˜3260 are collocated according to the tags “TOM”, “EDA”, and “MASK”. As a result, customer B can only access transaction data relating to tag blocks 3210˜3260 using another private key corresponding to the public key.

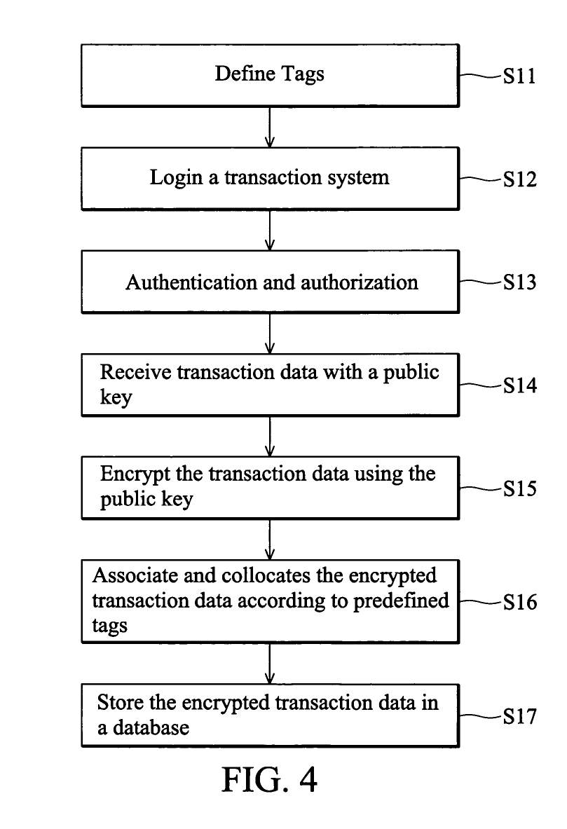

FIG.4 is a flowchart of an embodiment of a data archiving method.

Tags are first defined for data association and collocation (step S11). A transaction system is logged on via a transmission medium (the Internet) utilizing secure protocols (step S12). The transaction system executes authentication and authorization processes (step S13) and receives transaction data with a public key via the transmission medium (the Internet, local area network (LAN), or wireless network) (step S14). Next, the transaction system encrypts the transaction data using the public key (step S15), associates and collocates the encrypted transaction data according to predefined tags (step S16), and stores the encrypted transaction data in a database (step S17).

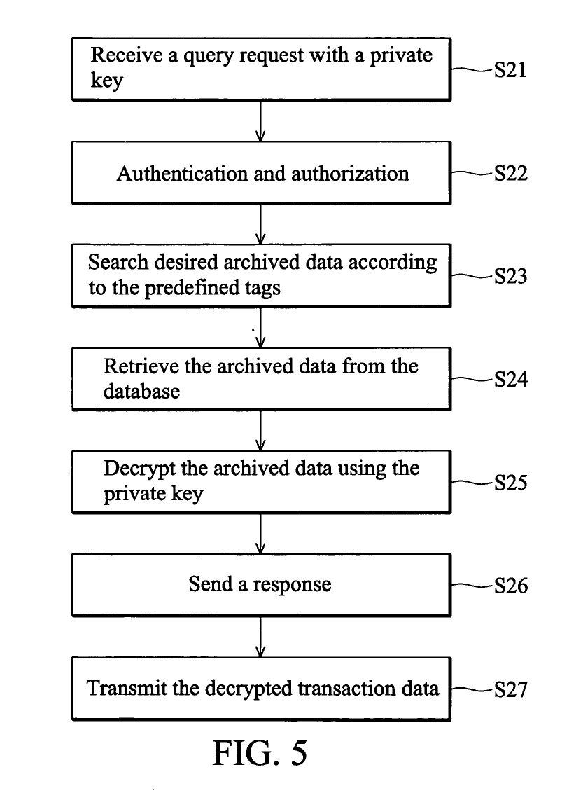

FIG. 5 is a flowchart of an embodiment of a data accessing method.

The transaction system receives a query request with a private key corresponding to the public key for access to tagged, associated, and collocated transaction data (step S21). Next, the transaction system executes authentication and authorization processes when receiving the request (step S22), searches for desired archived data according to the predefined tags (step S23), retrieves the archived data from the database (step S24), decrypts the archived data using the private key (step S25), sends a response (step S26), and transmits the decrypted transaction data (step S27).

The data archiving and accessing method of the invention provides a secure data archive that only the data owner having a corresponding private key can view and access. Additionally, the invention further allows a customer to effectively retrieve any related archived data from various systems according to the tags without requiring an entire system search. Thus, faster retrieval response time is achieved by predefined tag association and physical collocation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data archiving and accessing method, comprising:
defining tags for data archiving;
receiving transaction data with a public key via a transmission medium after executing authentication and authorization processes;
encrypting the transaction data using the public key;
associating and collocating the encrypted transaction data according to the tags; and
storing the encrypted, associated and collocated transaction data in a database.

2. The data archiving and accessing method as claimed in claim 1, further comprising locating and decrypting desired transaction data according to the tags using a private key corresponding to the public key.

3. The data archiving and accessing method as claimed in claim 1, wherein the transaction data is tagged and archived as tag blocks, each referring to a data type and comprising corresponding attributes.

4. The data archiving and accessing method as claimed in claim 1, wherein the tags comprise manufacturer, product, process, date, and any other representative attributes.

5. The data archiving and accessing method as claimed in claim 1, wherein the transmission medium is the Internet, LAN, or a wireless network.

6. A data archiving and accessing method, comprising:
archiving transaction data by:
defining tags for data archiving;
receiving the transaction data with a public key via a transmission medium after executing authentication and authorization processes;
encrypting the transaction data using the public key;
associating and collocating the encrypted transaction data according to the tags; and
storing the encrypted transaction data in a database; and
accessing desired transaction data by:
receiving a query request with a private key;
locating the desired transaction data according to the tags after authentication and authorization processes;
decrypting the desired transaction data using the private key; and
sending a response and transmitting the decrypted transaction data.

7. The data archiving and accessing method as claimed in claim 6, wherein the transaction data is tagged and archived as tag blocks, each referring to a data type and comprising corresponding attributes.

8. The data archiving and accessing method as claimed in claim 6, wherein the tags comprise manufacturer, product, process, date, and any other representative attributes.

9. The data archiving and accessing method as claimed in claim 6, wherein the transmission medium is the Internet, LAN, or a wireless network.

10. A data archiving and accessing system, comprising:
a client, uploading transaction data and a public key; and
a server, coupled to the client, further comprising:
a database, storing the transaction data; and
a transaction system, implementing authentication and authorization processes on the client, receiving the transaction data and public key via a transmission medium, encrypting the transaction data using the public key, associating and collocating the encrypted transaction data according to predefined tags, and storing the encrypted transaction data in the database.

11. The data archiving and accessing system as claimed in claim 10, wherein the transaction system locating and decrypting desired transaction data from the database according to the predefined tags using a private key corresponding to the public key.

12. The data archiving and accessing system as claimed in claim 10, wherein the transaction system tags and archives the transaction data as tag blocks, each referring to a data type and comprising corresponding attributes.

13. The data archiving and accessing system as claimed in claim 10, wherein the predefined tags comprise manufacturer, product, process, date, and any other representative attributes.

14. The data archiving and accessing system as claimed in claim 10, wherein the transmission medium is the Internet, LAN, or a wireless network.

15. A data archiving and accessing system, comprising:
a first client, uploading transaction data and a public key;
a server, coupled to the first client, further comprising:
a database, storing the transaction data; and
a transaction system, implementing authentication and authorization processes on the first client, receiving the transaction data and public key via a transmission medium, encrypting the transaction data using the public key, associating and collocating the encrypted transaction data according to predefined tags, storing the encrypted transaction data in the database, receiving a query request with a first private key from the first client, implementing authentication and authorization processes on the first client, locating desired transaction data from the database according to the predefined tags, decrypting the desired transaction data using the first private key, and sending a response and transmitting the decrypted transaction data to the first client.

16. The data archiving and accessing system as claimed in claim 15, wherein transaction system tags and archives the transaction data as tag blocks, each referring to a data type and comprising corresponding attributes.

17. The data archiving and accessing system as claimed in claim 15, wherein the predefined tags comprise manufacturer, product, process, date, and any other representative attributes.

18. The data archiving and accessing system as claimed in claim 15, wherein the transmission medium is the Internet, LAN, or a wireless network.

19. The data archiving and accessing system as claimed in claim 15, further comprising a second client, wherein the second client cannot retrieve the transaction data stored in the database using a second private key corresponding to the public key.
